(19) United States
(12) Patent Application Publication
(10) Pub. No.: US 2019/0132776 A1
(43) Pub. Date: May 2, 2019

(54) METHOD, SYSTEM AND APPARATUS FOR CHANNEL EVACUATION IN A WIRELESS NETWORK WITH SPECTRUM SHARING

(71) Applicant: Nokia Solutions and Networks Oy, Espoo (FI)

(72) Inventors: Christian MARKWART, Munich (DE); Bernhard WEGMANN, Holzkirchen (DE)

(21) Appl. No.: 16/094,756

(22) PCT Filed: Apr. 28, 2016
(86) PCT No.: PCT/EP2016/059507

§ 371 Date: Oct. 18, 2018

(51) Int. Cl. H04W 36/00; H04W 16/14; H04W 72/04

(52) U.S. Cl. CPC H04W 36/0072; H04W 72/0446; H04W 16/14

(57) ABSTRACT

There is provided a method comprising receiving first information from a spectrum management entity at an entity associated with a network, the first information comprising an indication that a first channel will not be available after a first time interval, receiving, during the first time interval, an indication of a second channel for use by the network and using the indication, during the first time interval, to cause initiation of a handover by at least one user device from the first channel to the second channel.

### FIELD

The present application relates to a method, apparatus, system and computer program and in particular but not exclusively to a method and apparatus for use in a network which may operate in a network resource sharing environment.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (the term used by 3GPP) networks. Standardization of 5G or New Radio networks is currently under discussion. LTE is being standardized by the 3rd Generation Partnership Project (3GPP).

In order to increase the available spectrum, it has been proposed to share network resources, or more specifically, spectrum resources, which can be used for radio technologies (for example UTRA, LTE and/or 5G technology).

### SUMMARY

There is provided a method comprising receiving first information from a spectrum management entity at an entity associated with a network, the first information comprising an indication that a first channel will not be available after a first time interval, receiving, during the first time interval, an indication of a second channel for use by the network and using the indication, during the first time interval, to cause initiation of a handover by at least one user device from the first channel to the second channel.

The first information may comprise the indication of the second channel. The indication may include details related to the second channel.

Receiving the indication of the second channel for use by the network may comprise providing a request for use of the second channel in response to receiving the first information and receiving a response from the spectrum management entity allowing use of the second channel.

The length of the first time interval may be such that the entity associated with the network is able to receive the indication of the second channel and cause initiation of the handover of the at least one user device before the end of the first time interval.

The entity associated with the network may comprise a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In a second aspect, there is provided a method comprising providing first information to an entity associated with a network, the first information comprising an indication that a first channel will not be available after a first time interval and providing, during the first time interval, an indication of a second channel for use by the network, wherein the indication is used by the entity associated with the network, during the first time interval, to cause initiation of a handover by at least one user device from the first channel to the second channel.

The first information may comprise the indication of the second channel. The indication may include details related to the second channel.

Providing the indication of the second channel for use by the network may comprise receiving a request for use of the second channel from the entity associated with the network in response to receiving the first information and providing a response to the entity associated with the network allowing use of the second channel.

The length of the first time interval may be such that the entity associated with the network is able to receive the indication of the second channel and cause initiation of the handover of the at least one user device before the end of the first time interval.

The entity associated with the network is a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In a third aspect, there is provided an apparatus comprising means for receiving first information from a spectrum management entity at an entity associated with a network, the first information comprising an indication that a first channel will not be available after a first time interval, means for receiving, during the first time interval, an indication of a second channel for use by the network and means for using the indication, during the first time interval, to cause initiation of a handover by at least one user device from the first channel to the second channel.

The first information may comprise the indication of the second channel. The information may include details related to the second channel.

Means for receiving the indication of the second channel for use by the network may comprise means for providing a request for use of the second channel in response to receiving the first information and means for receiving a response from the spectrum management entity allowing use of the second channel.

The length of the first time interval may be such that the entity associated with the network is able to receive the indication of the second channel and cause initiation of the handover of the at least one user device before the end of the first time interval.

The entity associated with the network may comprise a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In a fourth aspect, there is provided an apparatus comprising means for providing first information to an entity associated with a network, the first information comprising an indication that a first channel will not be available after a first time interval and means for providing, during the first time interval, an indication of a second channel for use by the network, wherein the indication is used by the entity associated with the network, during the first time interval, to cause initiation of a handover by at least one user device from the first channel to the second channel.

The first information may comprise the indication of the second channel. The indication may include details related to the second channel.

Means for providing the indication of the second channel for use by the network may comprise means for receiving a request for use of the second channel from the entity associated with the network in response to receiving the first information and means for providing a response to the entity associated with the network allowing use of the second channel.

The length of the first time interval may be such that the entity associated with the network is able to receive the indication of the second channel and cause initiation of the handover of the at least one user device before the end of the first time interval.

The entity associated with the network is a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In a fifth aspect, there is provided an apparatus comprising at least one processor and at least one memory including a computer program code, the at least one memory and the computer program code configured to, with the at least one processor, cause the apparatus at least to receive first information from a spectrum management entity at an entity associated with a network, the first information comprising an indication that a first channel will not be available after a first time interval, receive, during the first time interval, an indication of a second channel for use by the network and use the indication, during the first time interval, to cause initiation of a handover by at least one user device from the first channel to the second channel.

The first information may comprise the indication of the second channel. The indication may include details related to the second channel.

The apparatus may be configured to provide a request for use of the second channel in response to receiving the first information and receive a response from the spectrum management entity allowing use of the second channel.

The length of the first time interval may be such that the entity associated with the network is able to receive the indication of the second channel and cause initiation of the handover of the at least one user device before the end of the first time interval.

The entity associated with the network may comprise a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In a sixth aspect, there is provided an apparatus comprising at least one processor and at least one memory including a computer program code, the at least one memory and the computer program code configured to, with the at least one processor, cause the apparatus at least to provide first information to an entity associated with a network, the first information comprising an indication that a first channel will not be available after a first time interval and provide, during the first time interval, an indication of a second channel for use by the network, wherein the indication is used by the entity associated with the network, during the first time interval, to cause initiation of a handover by at least one user device from the first channel to the second channel.

The first information may comprise the indication of the second channel. The indication may include details related to the second channel.

The apparatus may be configured to receive a request for use of the second channel from the entity associated with the network in response to receiving the first information and provide a response to the entity associated with the network allowing use of the second channel.

The length of the first time interval may be such that the entity associated with the network is able to receive the indication of the second channel and cause initiation of the handover of the at least one user device before the end of the first time interval.

The entity associated with the network is a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In a seventh aspect, there is provided a computer program embodied on a non-transitory computer-readable storage medium, the computer program comprising program code for controlling a process to execute a process, the process comprising receiving first information from a spectrum management entity at an entity associated with a network, the first information comprising an indication that a first channel will not be available after a first time interval, receiving, during the first time interval, an indication of a second channel for use by the network and using the indication, during the first time interval, to cause initiation of a handover by at least one user device from the first channel to the second channel.

The first information may comprise the indication of the second channel. The indication may include.

Receiving the indication of the second channel for use by the network may comprise providing a request for use of the second channel in response to receiving the first information and receiving a response from the spectrum management entity allowing use of the second channel.

The length of the first time interval may be such that the entity associated with the network is able to receive the indication of the second channel and cause initiation of the handover of the at least one user device before the end of the first time interval.

The entity associated with the network may comprise a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In an eighth aspect, there is provided a computer program embodied on a non-transitory computer-readable storage medium, the computer program comprising program code for controlling a process to execute a process, the process comprising providing first information to an entity associated with a network, the first information comprising an indication that a first channel will not be available after a first time interval and providing, during the first time interval, an indication of a second channel for use by the network, wherein the indication is used by the entity associated with the network, during the first time interval, to cause initiation of a handover by at least one user device from the first channel to the second channel.

The first information may comprise the indication of the second channel. The indication may include details related to the second channel.

Providing the indication of the second channel for use by the network may comprise receiving a request for use of the second channel from the entity associated with the network in response to receiving the first information and providing a response to the entity associated with the network allowing use of the second channel.

The length of the first time interval may be such that the entity associated with the network is able to receive the indication of the second channel and cause initiation of the handover of the at least one user device before the end of the first time interval.

The entity associated with the network is a network entity configured to operate on behalf of at least one base station of the network.

The spectrum management entity may be configured to manage a spectrum resource shared by a plurality of network operators.

The first channel may comprise a first portion of the spectrum resource. The second channel may comprise a second portion of the spectrum resource.

The first information may comprise an indication of the first time interval.

The first time interval may be preconfigured at the entity associated with the network.

In a ninth aspect there is provided a computer program product for a computer, comprising software code portions for performing the steps the method of the first and second aspect when said product is run on the computer.

A device for a communication system may comprise the apparatus according to the above aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a plurality of base stations and a plurality of communication devices;

FIG. 2 shows a schematic diagram of an example mobile communication device;

FIG. 3 shows a schematic diagram of a an interface between a management entity and a network entity in which embodiments may be performed;

FIG. 4 shows a flowchart of an example method according to some embodiments;

FIG. 5 shows an example signalling flow between a management entity, network entity and a user device according to some embodiments;

FIG. 6 shows an example signalling flow between a management entity, network entity and a user device according to some embodiments;

FIG. 7 shows a schematic diagram of an example control apparatus.

### DETAILED DESCRIPTION

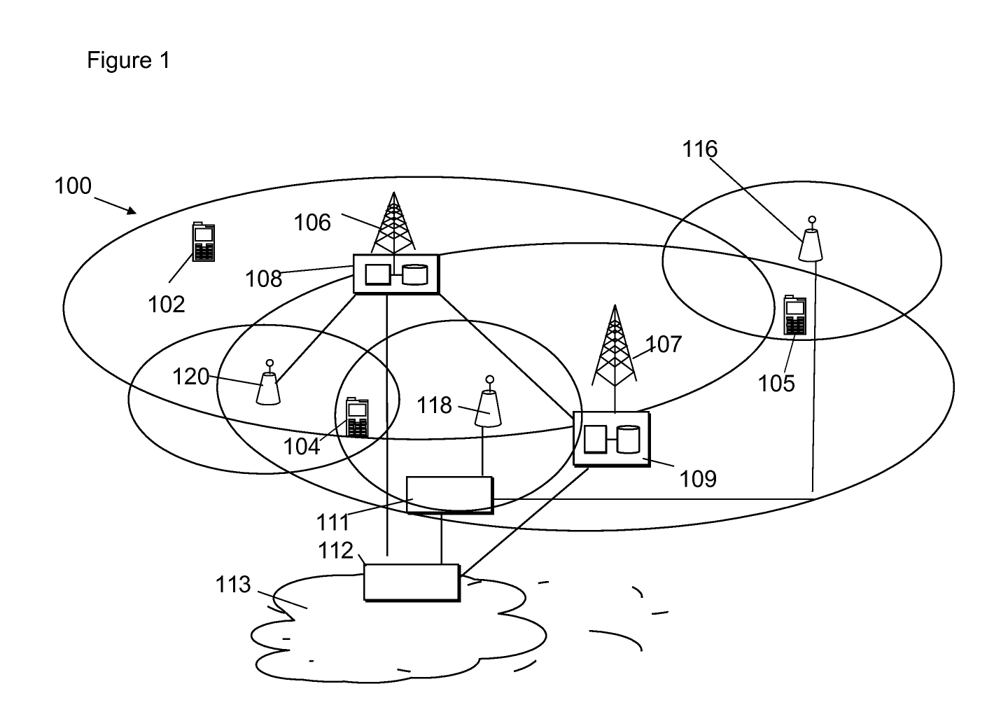

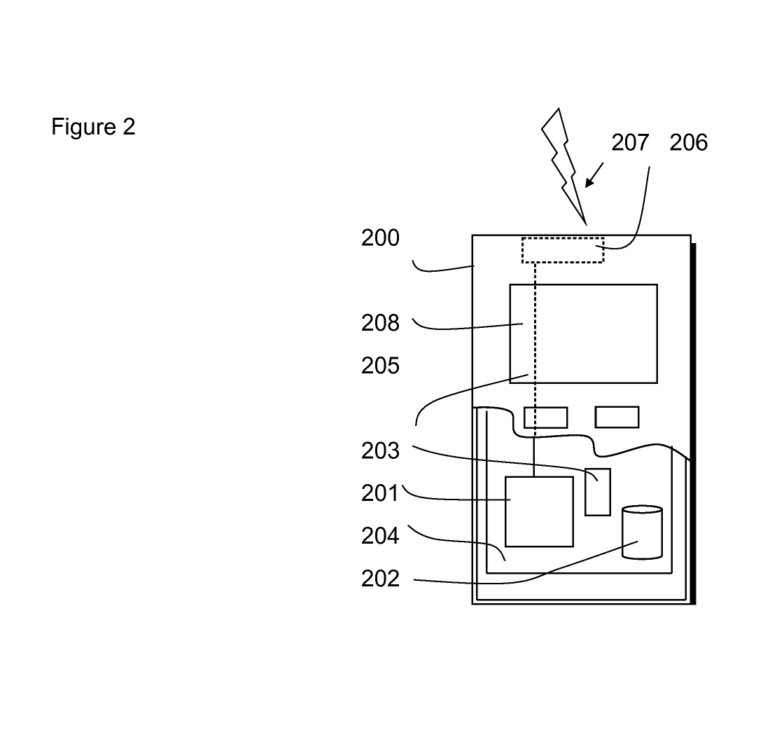

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. A base station is referred to as an eNodeB (eNB) in LTE. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller.

LTE systems may however be considered to have a so-called “flat” architecture, without the provision of RNCs; rather the eNB is in communication with a system architecture evolution gateway (SAE-GW) and a mobility management entity (MME), which entities may also be pooled meaning that a plurality of these nodes may serve a plurality (set) of eNBs. Each UE is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto. The communication devices 102, 104, 105 may access the communication system based on various access techniques.

An example of wireless communication systems are architectures standardized by the 3rd Generation Partnership Project (3GPP). A latest 3GPP based development is often referred to as the long term evolution (LTE) or LTE Advanced Pro of the Universal Mobile Telecommunications System (UMTS) radio-access technology. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

For more efficient spectrum utilization, wireless communication systems may be allowed to operate in unlicensed or licensed-shared spectrum bands, as well as or instead of licensed spectrum bands. A technology, for example LTE, may operate, in addition to a licensed band, in an unlicensed band. One proposal for operating in unlicensed spectrum is Licensed-Assisted Access (LAA). Currently, it is proposed with LAA that a connection via a licensed band can be enhanced by adding another second carrier being operated in the unlicensed band. LAA does not provide standalone LTE operation on unlicensed spectrum.

LTE standalone operation on unlicensed spectrum or temporarily shared spectrum resources means that the eNB/UE air interface relies solely on unlicensed or temporarily shared spectrum without any carrier on licensed spectrum. An example of LTE standalone operation in unlicensed bands is the MuLTEfire technology proposed by the MuLTEfire Alliance.

The following relates to network resource or spectrum resource sharing. Unlicensed bands are per se shared, but spectrum sharing may also use licensed bands. For example, LSA is a sharing method where the Incumbent network has a license and the Operator requires another so called LSA License before he is allowed to use the spectrum bands.

The Spectrum Access System (SAS) is another spectrum management approach, designed for US 3.5 GHz band, and based on a three-tier sharing, i.e. three priority levels.

The following may be applicable to stand-alone radio access technologies (RAT) as provided, for example, by MuLTEfire RAN, which comprise base stations (Macro, Pico and Femto), enabled to use shared spectrum that is organized by an external spectrum management entity. In addition to licensed and license-exempt (unlicensed) authorization methods, spectrum sharing concepts such as Licensed Shared Access (LSA), co-primary spectrum sharing, and multitier sharing via a Spectrum Access System (SAS) may be used to provide additional capacity to mobile networks. Independent from the authorization method, spectrum management approaches may be required needed to meet the requirements on flexible spectrum usage.

In order to open the usage of shared spectrum to “new operators”, which do not own licensed spectrum, LTE-based RAT concepts are developed that may allow, for example, operation of an eNB in a so-called LTE stand-alone mode. The respective functionality is under discussion in groups such as the MuLTEfire Alliance or the CBSD Consortium.

Some embodiments may support regular LTE by extending LTE service into unlicensed radio band or shared spectrum using, for example, a so-called MuLTEfire radio. However it should be appreciated that embodiments are not limited to a MuLTEfire radio, or a LTE type of cellular service, and could support e.g., a 3G radio service or a 5G radio service.

Contrary to traditional exclusive spectrum assignment, spectrum sharing is a method where spectrum resources may no longer be exclusively assigned to a single operator but jointly assigned to several operators with the obligation to use it collectively. Each spectrum resource is defined by a spectrum, a location where this spectrum is used, and a time frame when the spectrum is used.

Since the used spectrum is not owned but only temporarily shared, LSA and multitier spectrum sharing are typical examples where an external management entity decides, based on defined sharing rules, which spectrum resource is provided to a requesting mobile network. The spectrum resource may be owned by an Incumbent (primary user), who allows other operators to use this spectrum resource for their purpose.

LSA and multitier spectrum sharing are designed to support dynamic spectrum sharing options. While static spectrum sharing has no time dependencies and the Network Operator is allowed to use the spectrum similarly to dedicated licensed spectrum, dynamic spectrum sharing provides flexible controlling of shared spectrum resources via a management entity (e.g. LSA Repository or Spectrum Access System).

The management entity and the information exchange with the operator network on shared spectrum resources are being considered.

For example, in terms of using LTE in standalone mode in US 3.5 GHz band, MuLTEfire is one option for commercial mobile communication known as Citizens Broadband Radio Service (CBRS) controlled by a so-called SAS (Spectrum Access System). SAS coordinates the carrier assignment among the CBRS providers operating the eNBs. The CBRS providers may be categorized into a three-tier hierarchy with following order of priority: (1) incumbent licensees (e.g. military), (2) Priority Access licensees (PAL) and (3) General Authorized Access (GAA) operators.

Shared spectrum may have a similar behaviour to unlicensed spectrum, particularly GAA usage of spectrum. PAL usage may differ, because the SAS has to protect PAL users against interference from GAA and other PAL users. Spectrum resources (channels) assigned to GAA operators can be withdrawn on very short notice by the SAS and another channel may be assigned. Therefore, these GAA operators are faced with a so-called mass handover situation that all active users has to be handed over to another channels.

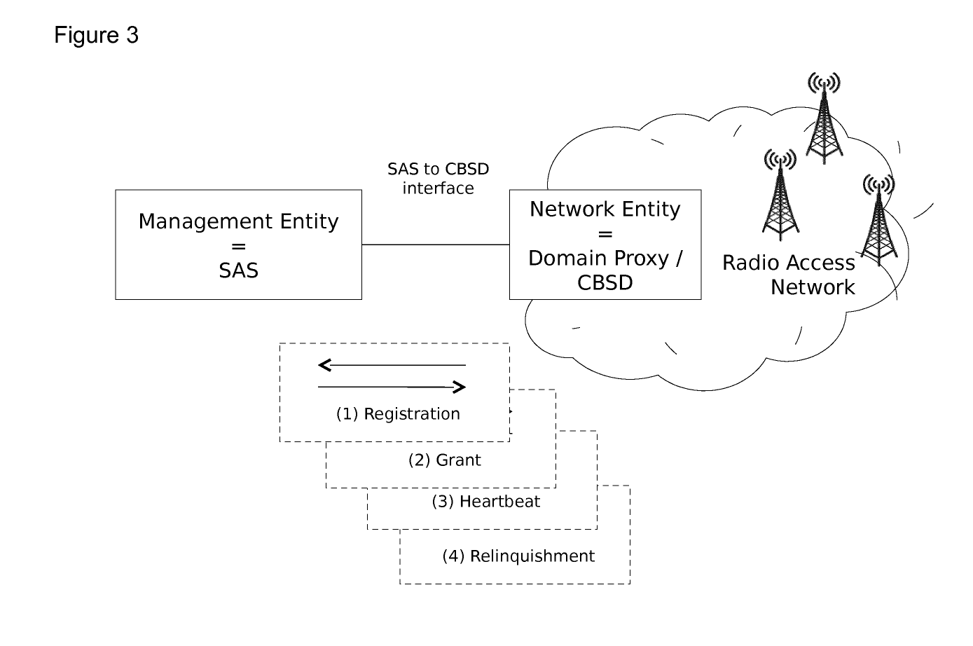

FIG. 3 shows this principle for sharing methods for, e.g., multitier sharing, where a SAS represents a management entity and a citizens broadband service device (CBSD) (or domain proxy), a network entity which provides the entry point for the mobile network. In the CBSD example, the SAS may provide a channel in the 3.5 GHz band to an eNB (i.e. CBSD). A set of procedures for spectrum resource sharing haw been defined to describe the general communication concept between the management entity and the network.

An example set of procedures is shown in FIG. 3. The communication is initiated by the CBSD. In step (1), the CBSD registers with the SAS using the CBSD's credentials. When registration is successful, step (2) is started where the CBSD requests, for its location, a grant for at least one channel (typically a 10 MHz LTE component carrier) in the 3.5 GHz band. When the grant is successful, the CBSD initiates in step (3) a periodic heartbeat request response mechanism. Via the heartbeat request-response exchange, SAS controls the availability of the grant and allows the CBSD to transmit on the granted channel(s).

When a grant expires or the SAS informs the CBSD in the heartbeat response that the grant is no longer available, the CBSD has to relinquish the granted channel(s) in step (4).

For the standardized methods LAA and LTE-U such an abrupt transmitter off and relinquishment of the shared spectrum would reduce UE throughput in the considered area, but would not cause connection failures because there is still an anchor in the licensed band. In the case of standalone MuLTEfire, without a fall back solution provided by the licensed anchor, users will drop connection in that area followed by new connection setups including authentication procedure, etc. Providing service continuation for the users affected by the channel change may be desirable.

Granting of multiple channels, which may allow standalone installations like MuLTEfire to blindly request for one other channel (i.e. at least 2 channels) has been considered. The second channel is then held as backup to overcome a service outage, even though only one channel is usually sufficient. This option may only help if the SAS terminates only one of the two granted channels. This option may not help if both channels are to be released simultaneously. Furthermore, it may be a waste of resources and/or not feasible in locations with ultra-dense deployments to grant multiple channels.

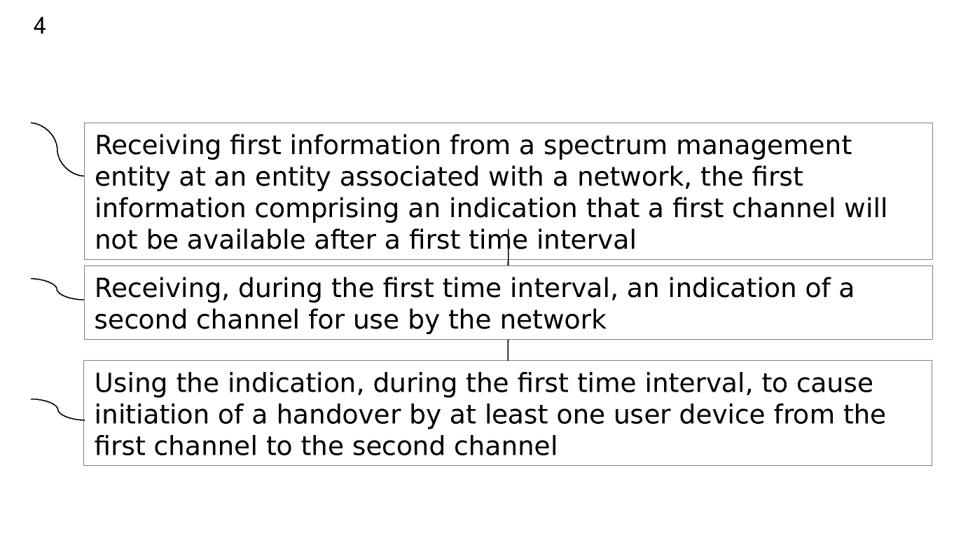

FIG. 4 shows a flowchart of an example method according to some embodiments. In a first step, S1, the method comprises receiving first information from a spectrum management entity at an entity associated with a network, the first information comprising an indication that a first channel will not be available after a first time interval.

In a second step, S2, the method comprises receiving, during the first time interval, an indication of a second channel for use by the network.

In a third step, S3, the method comprises using the indication, during the first time interval, to cause initiation of a handover by at least one user device from the first channel to the second channel.

The length of the first time interval may be such that the entity associated with the network is able to receive the indication of the second channel and cause initiation of the handover of the at least one user device before the end of the first time interval

The spectrum management entity may be configured to manage a spectrum resource shared by a plurality of network operators. The network operators may be public MNOs or “new” operators as described above. The spectrum management entity may be an SAS (for CBSD) or LSA repository (for LSA).

The entity associated with the network may be referred to as a network entity. The network entity may comprise a network entity configured to operate on behalf of at least one base station of the network. The method may be used in a multitier spectrum sharing system, e.g. CBSD communications system. The network entity may comprise, for example, a citizens broadcast device and/or a domain proxy. Alternatively, or in addition, the method may be used in other spectrum sharing systems, such as dynamic LSA. The network entity may comprise an LSA controller.

The first channel may comprise a first portion of a spectrum resource. The second channel may comprise a second portion of a spectrum resource. A spectrum resource may be defined by a spectrum (frequency range), a location where the spectrum is to be used and a time frame when the spectrum is to be used.

The indication that a first channel will not be available after a first time interval may be a channel grant suspension or grant termination provided in a heartbeat response. A method as described with reference to FIG. 4 may provide an extension of the SAS-CBSD interface such that one or more potential channels are organized as alternative channels in line with the time of the channel grant suspension or grant termination information. The CBSD (e.g. MuLTEfire eNB) may then organize service continuity of its serving active UEs. The method may operate independently of whether the SAS is communicating with a domain proxy (DP) acting on behalf of the CBSD as network element between SAS and CBSD or directly with the CBSD. Thus, in the following, the term CBSD is used for both network elements DP and CBSD.

The first time interval may be referred to as t_{transmit max}. The time t_{transmit max} defines the maximum time the network entity is allowed to use the channel(s) before transmission has to stop after receiving an indication that the first channel will not be available, e.g., a heartbeat response with a grant suspension or grant termination. The time t_{transmit max} may be long enough that the network entity can arrange a seamless handover of all active UEs to the second channel or at least that all UE are prepared in a way that, in case of handover failures, a fast re-establishment to the second channel is possible.

The first interval may be preconfigured at the network entity. For example, t_{transmit max} may be configured by means of OAM as parameter at the CBSD based on contract terms and conditions between incumbent and licensee, and the OAM.

Alternatively, or in addition, the first information may comprise an indication of the first time interval. For example, the time t_{transmit max} may be provided as parameter in the respective heartbeat response by the SAS.

In an embodiment the first information may comprise the indication of the second channel. The indication may include further details, e.g. parameters, related to the second channel. For example, the spectrum management entity, e.g. SAS, may send in the Heartbeat Response message the information “grant suspension” or “grant termination” for the channel(s) CH x and the grant of the one or more alternative channel(s) CH y.

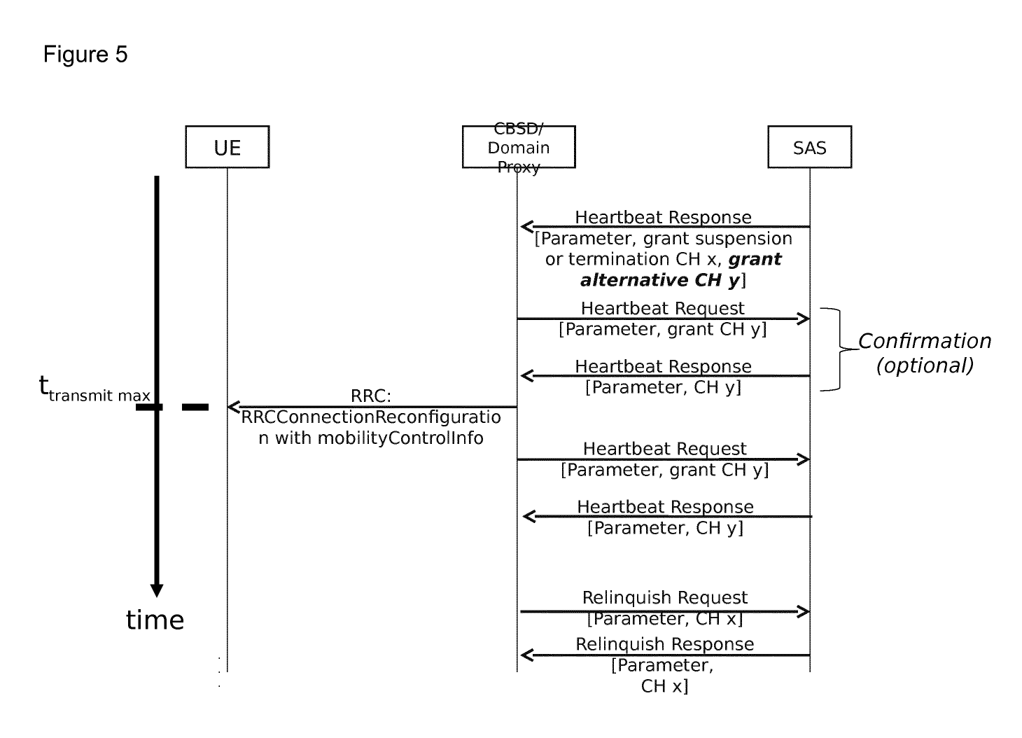

FIG. 5 shows an example a signalling diagram which may be used in an embodiment. The embodiment is described for a CBRS communication system. In FIG. 5, the SAS provides, together with the channel grant suspension or grant termination, information indicating one or more alternative channels (e.g. component carriers in case of the LTE derivate MuLTEfire) which can be used on RAN side for preparing a seamless channel change before the transmission on the previous channel(s) has to be ultimately stopped.

Knowing the time t_{transmit max} and the new channel, the CBSD prepares the serving active UEs such that seamless service continuity can be guaranteed.

The CBSD initiates periodic heartbeats for the channel(s) CH y and processes the grant suspension or grant termination of the previous channel(s) CH x accordingly (e.g. start Relinquish procedure in case of grant termination or wait until grant suspension of previous channel(s) CH x is reset by SAS). In case that the information “grant alternative” does not include the allowance for the CBSD to transmit on the channel(s) CH y, the CBSD has to wait until the alternative channel(s) are confirmed by the SAS via the first Heartbeat Response message for the alternative channel(s) CH y before the active UEs can be reconfigured.

Alternatively, the network entity, e.g. CBSD, may initiate the process. In one embodiment, receiving the indication of the second channel may comprise providing a request to the spectrum management entity for use of the second channel in response to receiving the first information. In that case, the spectrum management entity would not proactively provide alternative channels, but provides sufficient time (t_{transmit max}) until the transmitter of the previous channel(s) CH x is switched off. With sufficient time tₜᵣₐₙₛₘᵢₜ max the network entity may be able to organize the required means to guarantee seamless service continuity.

In an embodiment where the network entity initiates the process, the response from the spectrum management entity may allow the usage of the alternative channel(s) CH y before t_{transmit max}. The grant request-response for the alternative channel(s) may need to be performed several times before SAS provides alternative channel(s) successfully.

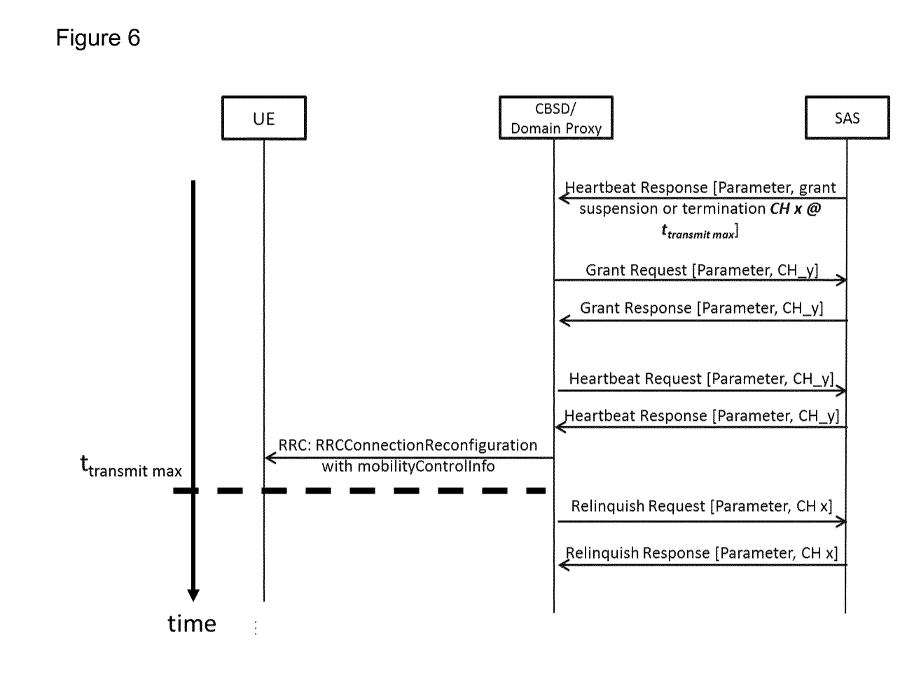

FIG. 6 shows an example a signalling diagram which may be used in an embodiment. The embodiment is described for a CBRS communication system. In FIG. 6, the CBSD makes a grant request for CH y, and the SAS provides a grant response for the CH y, allowing use of the CH y.

Causing initiation of a handover by the at least one user device from the first channel to the second channel may be performed in any suitable way. Depending on network entity capabilities, e.g. a network entity (MuLTEfire eNB such as CBSD) equipped with more than one component carrier or one single component carrier, the arrangement of seamless service continuity of the active UEs is different. In the case of a network entity with more than one carrier, the network entity may configure all active UEs served on channel CH x with an RRCConnectionReconfiguration with mobilityControlInfo message, as soon as the UE is transmitting on both channels. That is, the network entity initiates for all UEs a normal inter-frequency handover to the alternative channel CH y or guarantees at least re-establishment in case the handover fails.

In the case of a network entity equipped only with one single component carrier, the channel change becomes a hard change where CH x stops and CH y concurrently starts transmitting. In in this case, a normal inter-frequency handover is no longer sufficient and a controlled mass handover of all active UEs may be necessary. For the latter case, the timing in terms of preparation and execution of the mass handover gets an important role, since the network entity determines the time instance for the hard channel change combined with mass handover.

It should be understood that each block of the flowchart of the Figures and any combination thereof may be implemented by various means or their combinations, such as hardware, software, firmware, one or more processors and/or circuitry.

It is noted that whilst embodiments have been described in relation to one example of a standalone LTE network, similar principles may be applied in relation to other examples of standalone 3G, LTE or 5G networks. It should be noted that other embodiments may be based on other cellular technology other than LTE or on variants of LTE. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

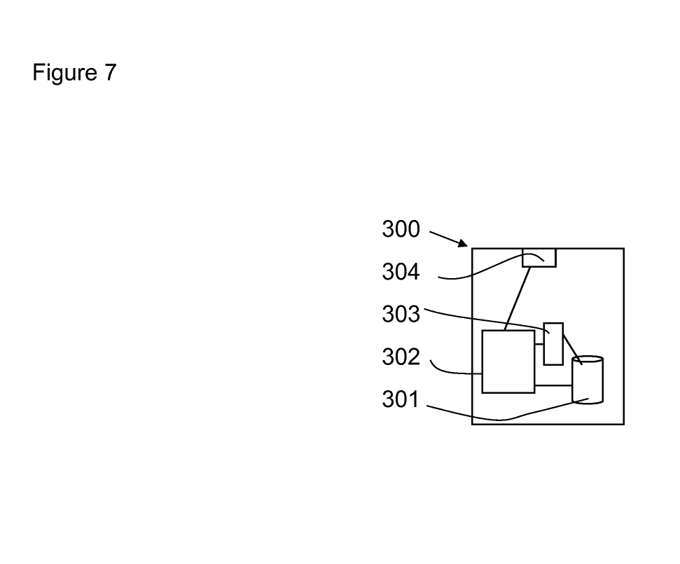

The method may be implemented in such as a control apparatus as shown in FIG. 7. The method may be implanted in a single processor 201 or control apparatus or across more than one processor or control apparatus. FIG. 7 shows an example of a control apparatus for a communication system, for example to be coupled to and/or for controlling a station of an access system, such as a RAN node, e.g. a base station, (e) node B, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions. Control functions may comprise receiving first information from a spectrum management entity at an entity associated with a network, the first information comprising an indication that a first channel will not be available after a first time interval, receiving an indication of a second channel for use by the network and using the indication to cause initiation of a handover by at least one user device from the first channel to the second channel, wherein the length of the first time interval is such that the entity associated with the network is able to receive the indication of the second channel and cause initiation of the handover of the at least one user device before the end of the first time interval.

Alternatively, or in addition, control functions may comprise providing first information to an entity associated with a network, the first information comprising an indication that a first channel will not be available after a first time interval and providing an indication of a second channel for use by the network, wherein the indication is used by the entity associated with the network to cause initiation of a handover by at least one user device from the first channel to the second channel, wherein the length of the first time interval is such that the entity associated with the network is able to receive the indication of the second channel and cause initiation of the handover of the at least one user device before the end of the first time interval.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-22. (canceled)

23. A method comprising:
receiving first information from a spectrum management entity at an entity associated with a network, the first information comprising an availability indication that a first channel will not be available after a first time interval;
receiving, during the first time interval, an indication of a second channel for use by the network; and
using the availability indication, during the first time interval, to cause initiation of a handover by at least one user device from the first channel to the second channel.

24. A method according to claim 23, wherein the first information comprises the indication of the second channel.

25. A method according to claim 23, wherein receiving the indication of the second channel for use by the network comprises providing a request for use of the second channel in response to receiving the first information; and
receiving a response from the spectrum management entity allowing use of the second channel.

26. A method according to any claim 23, wherein the length of the first time interval is such that the entity associated with the network is able to receive the indication of the second channel and cause the initiation of the handover of the at least one user device before the end of the first time interval.

27. A method according to claim 25, wherein the entity associated with the network is a network entity being configured to operate on behalf of at least one base station of the network.

28. A method according to claim 23, wherein the spectrum management entity is configured to manage a spectrum resource shared by a plurality of network operators.

29. A method according to claim 28, wherein the first channel comprises a first portion of the spectrum resource and the second channel comprises a second portion of the spectrum resource.

30. A method according to claim 23, wherein the first information comprises an indication of the first time interval.

31. A method according to claim 23, wherein the first time interval is preconfigured at the entity associated with the network.

32. A method comprising:
providing first information to an entity associated with a network, the first information comprising an availability indication that a first channel will not be available after a first time interval; and
providing, during the first time interval, an indication of a second channel for use by the network, wherein the availability indication is used by the entity associated with the network, during the first time interval, to cause initiation of a handover by at least one user device from the first channel to the second channel.

33. A method according to claim 32, wherein the first information comprises the indication of the second channel.

34. A method according to claim 32, wherein providing the indication of the second channel for use by the network comprises receiving a request for use of the second channel from the entity associated with the network in response to receiving the first information; and
providing a response to the entity associated with the network allowing use of the second channel.

35. A method according to claim 32, wherein the length of the first time interval is such that the entity associated with the network is able to receive the indication of the second channel and cause the initiation of the handover of the at least one user device before the end of the first time interval.

36. A method according to claim 32, wherein the entity associated with the network is a network entity being configured to operate on behalf of at least one base station of the network.

37. A method according to claim 32, wherein the spectrum management entity is configured to manage a spectrum resource shared by a plurality of network operators.

38. A method according to claim 37, wherein the first channel comprises a first portion of the spectrum resource and the second channel comprises a second portion of the spectrum resource.

39. An apparatus comprising:
at least one processor and at least one memory including a computer program code, the at least one memory and the computer program code configured to, with the at least one processor, cause the apparatus at least to:
receive first information from a spectrum management entity at an entity associated with a network, the first information comprising an availability indication that a first channel will not be available after a first time interval;
receive, during the first time interval, an indication of a second channel for use by the network; and
use the availability indication, during the first time interval, to cause initiation of a handover by at least one user device from the first channel to the second channel.

40. An apparatus comprising:
at least one processor and at least one memory including a computer program code, the at least one memory and the computer program code configured to, with the at least one processor, cause the apparatus at least to:
provide first information to an entity associated with a network, the first information comprising an availability indication that a first channel will not be available after a first time interval; and
provide, during the first time interval, an indication of a second channel for use by the network, wherein the availabiltity indication is used by the entity associated with the network, during the first time interval, to cause initiation of a handover by at least one user device from the first channel to the second channel.

41. A non-transitory computer readable medium storing a program of instructions, execution of which by a processor configures an apparatus to at least:
receive first information from a spectrum management entity at an entity associated with a network, the first information comprising an availability indication that a first channel will not be available after a first time interval;
receive, during the first time interval, an indication of a second channel for use by the network; and
use the availability indication, during the first time interval, to cause initiation of a handover by at least one user device from the first channel to the second channel.

42. A non-transitory computer readable medium storing a program of instructions, execution of which by a processor configures an apparatus to at least:
provide first information to an entity associated with a network, the first information comprising an availability indication that a first channel will not be available after a first time interval; and
provide, during the first time interval, an indication of a second channel for use by the network, wherein the availability indication is used by the entity associated with the network, during the first time interval, to cause initiation of a handover by at least one user device from the first channel to the second channel.
